(19) United States
(12) Patent Application Publication
(10) Pub. No.: US 2005/0036674 A1
(43) Pub. Date: Feb. 17, 2005

(54) Method and system for determining shape of an object from a planar top view thereof

(75) Inventors: Avraham Be'er, Ramat Gan (IL); Yossi Lereah, Petah Tikva (IL); Haim Taitelbaum, Givat Shmuel (IL)

Correspondence Address: BROWDY AND NEIMARK, P.L.L.C.;624 NINTH STREET, NW, SUITE 300, WASHINGTON, DC, 20001-5303, US

(73) Assignee: Bar Ilan University, Ramat Gan (IL)

(21) Appl. No.: 10/916,408

(22) Filed: Aug. 12, 2004

Related U.S. Application Data
(60) Provisional application No. 60/494,564, filed on Aug. 13, 2003.

(51) Int. Cl. G06K 9/00

(52) U.S. Cl. 382/154

(57) ABSTRACT

A method and system for determining a shape of a three-dimensional object from a planar top view thereof images the object on a planar substrate using a Differential Interference Contrast light microscope so that the object reflects from different points of a surface of the object colors that are indicative of a slope of the surface at each respective point. Successive digital color images are generated having a plurality of pixels each having a hue that correlates to a unique slope of the surface corresponding to the pixel. The slope of the surface at each point is inferred using a pre-calibrated color-depth characteristic derived using a sample formed of an identical material to the object to calculate local slope for each pixel. In a practical system, a user specifies a type of material being imaged and a corresponding color-depth characteristic is read that may be stored in a pre-compiled database.

### FIELD OF THE INVENTION

The present invention relates to optical systems for quantifying the 3-D shapes of opaque (and transparence) substrates, in particular with high time resolution.

### REFERENCES

The following prior art references provide background material relating to the subject matter of the present invention.
[1] Aveyard, R., Clint, J. H., Nees, D., Paunov, V., Colloids and Surfaces A 146, 95-111 Size-Dependent Lens Angles for Small Oil Lenses on Water (1999).
[2] Bain, C. D., Burnett-Hall, G. D., Montgomerie, R. R., Nature 372, 414-415 Rapid Motion of Liquid Drops (1994).
[3] Be'er, A., Lereah, Y., Taitelbaum, H., Physica A 285, 156-165 The Dynamics and Geometry of Solid-Liquid Reaction Interface (2000).
[4] Be'er, A., Lereah, Y., Hecht, I., Taitelbaum, H., Physica A 302, 297-301 The Roughness and Growth of a Silver-Mercury Reaction Interface (2001).
[5] de Gennes, P. G., Physica A 249, 196-205 The Dynamics of Reactive Wetting on Solid Surfaces (1998).
[6] de Gennes, P. G., Rev. Mod. Phys. 57, 828-863 Wetting: Statics and Dynamics (1985).
[7] de Ruijter, M. J., De Coninck, J. and Oshanin, G., Langmuir 15, 2209-2216 Droplet Spreading: Partial Wetting Regime Revisited (1999).
[8] de Ruijter, M. J., De Coninck, J., Blake, T. D., Clarke, A., Rankin, A., Langmuir 13, 7293-7298 Contact Angle Relaxation during the Spreading of Partially Wetting Drops (1997).
[9] Domingues dos Santos, F., Ondarcuhu, T., Phys. Rev. Lett. 75, 2972-2975 Free-Running Droplets (1995).
[10] Eustathopoulos, N., Acta Metallurgica 46, 2319-2327 Dynamics of Wetting in Reactive Metal/Ceramic Systems (1998).
[11] Landry, K. and Eustathopoulos, N., Acta Metallurgica 44, 3923-3932 Dynamics of Wetting in Reactive Metal/Ceramic Systems: Linear Spreading (1996).
[12] Liu, Y. M. and Chuang, T. H., J. of Electronic Materials, 29, 405-410 Interfacial Reactions between Liquid Indium and Au-Deposited Substrates (2000).
[13] Robinson, P. C., and Bradbury, S., Qualitative Polarized-Light Microscopy, (Oxford University Press, 1992).

### BACKGROUND OF THE INVENTION

The need to quantify the 3-D shapes of opaque (and transparence) substrates, in particular with high time resolution, is highly important for several fields, such as physics, optics, chemistry, biology and material science. Soldering, typing, printing and coating of solids with liquids are only a few commercial examples for which this requirement is highly important.

The light microscope is an excellent tool for collecting 2D information and a wide range of stereo-techniques is available. However, the limit of conventional light microscopy for 3D qualitative and quantitative information is a long-standing problem. The limited field depth prevents simultaneous qualitative information—i.e. a fall 3D image in one view. Moreover, the nature of the projected view prevents the 3D quantification of the object. Various methods have been developed to overcome this problem. The scanning electron microscope (SEM) that has a large field depth is most popular for 3D imaging. It also enables quantitative 3D evaluation by stereo-coupled images. Other well-known devices are the confocal microscope and the atomic force microscope (AFM). These devices enable the gathering of 3D information, but suffer from several limitations. One limitation is the long acquisition time of the quantitative 3D information (order of minutes), and hence time resolved microscopy by these methods is limited to these time scales.

The wetting of solid surfaces by liquid droplets is an important process in material science and technology with a diverse range of applications, e.g. soldering and painting. Liquids wet solids, completely or partially, depending on the surface tension coefficients of the materials. The equilibrium contact angle, θ_{eq} for partial wetting is given by:
γₛᵥ=γₛₗ+γₗᵥ cos θ_{eq} (1)
where γᵢⱼ is the surface tension coefficient between phase i and phase j (solid, liquid or vapor), respectively.

Recent studies (Landry & Eustathopoulos [11]; Eustathopoulos [10]; Liu & Chuang [12]; and de Ruijter et al. [7], [8]) have focused on the dynamics of the droplet towards reaching its final state. Assuming partial wetting (0°<θ<180°), as the initial state of the droplet, it will spread (prior to equilibrium) as long as S=γₛᵥ−γₗᵥ−γₛₗ (“power” of the spreading) is positive. In the case of complete wetting (θ=0°), one has γₛₗ+γₗᵥ<γₛᵥ and equation (1) is not satisfied, i.e. S≧0. Note that equation (1) refers only to the contact angle and not to the entire droplet's shape and its evolution with time. Theoretical studies (de Ruijter et al. [7], [8] and de Gennes [6]) assume that for small droplets, i.e. where gravity is negligible, and for small angles (θ<<1 radian), the droplet has a spherical-cup-shape. Under the spherical-cup-shape approximation the evolution of the droplet shape is described either by its time dependent radius R(t), or by the time dependent angle of contact θ(t), which are related through

$${H}_{0} ( t ) = R ( t ) \cdot tan \frac{θ ( t )}{2} ,$$

and for small angles (θ<30°)

$${H}_{0} ( t ) = \frac{1}{2} R ( t ) \cdot θ ( t )$$

where H₀(t) is the height of the center of the droplet. The radius R(t) and the angle of contact θ(t) of the advancing droplet, were found, in both experimental and theoretical studies (de Ruijter et al. [7], [8] and de Gennes [6]), to obey a power law with two major regimes: R(t)˜t^{1/7} and θ(t)˜t^{-3/7} at the early stages, and R(t)˜t^{1/10} and θ(t)˜t^{-3/10} during long-time relaxation to the equilibrium stage.

It has been shown by Landry & Eustathopoulos [11]; Eustathopoulos [10]; Liu & Chuang [12]; de Gennes [5]; Bain et al. [2]; Domingues et al. [9]; and Be'er et al. [3] that during the interaction of a metal droplet on a metal substrate, both wetting and chemical reactions govern the dynamics of the process. In such cases, the time dependence of the radius and the angle of contact do not obey a power law. Moreover, a single function can hardly describe the full range of such wetting curves, and a wetting regime corresponding to R(t)˜t is observed for a part of the spreading time (Landry & Eustathopoulos [11]; Eustathopoulos [10]; Liu & Chuang [12]). In this context one of the present inventors has found (Be'er et al. [3]) that Hg droplets tend to propagate spontaneously on Ag surfaces causing a nearly complete wetting formation, i.e. θ→0°.

Several methods have been used to detect the shapes of such droplets, but none of them can follow the evolution of the droplet shape with time.

(i) In a top view of transparent droplets on transparent substrates, like oils on glass, the droplet is considered as an optical lens (Aveyard et al. [1]). By knowing the index of refraction and the focal length of the droplet-lens, one can infer the exact three-dimensional shape of the droplets.

(ii) A side view of opaque droplets (de Ruijter et al. [8]). This method gives limited information owing to the depth of the focus and to the projected view.

### SUMMARY OF THE INVENTION

It is therefore a principal object of the invention to provide an improved method for determining a shape of a three-dimensional object from a planar top view thereof.

It is a particular object of the invention to provide such a method that may used at high time resolution so as, for example, to follow the evolution of a droplet shape with time.

These objects are realized in accordance with a broad aspect of the invention by a method for determining a shape of a three-dimensional object from a planar top view thereof, said object being amenable to reflecting light, the method comprising:

imaging the object on a planar substrate using a DIC (Differential Interference Contrast) light microscope so that the object reflects from different points of a surface of the object colors that are indicative of a slope of the surface at each respective point; and

inferring the slope of the surface at each point based on the respective color.

In a particular application of such a method there is provided a method for evaluating a shape of a liquid droplet as it interacts with a planar substrate, the method comprising:

imaging the liquid droplet as it interacts with the planar substrate using a DIC (Differential Interference Contrast) light microscope for time resolved image acquisition of steps in the planar substrate, each step having a respective colors indicative of a slope of the step;

inferring a slope of each step based on its color; and

using information representative of the respective slopes of the steps to perform 3D quantitative evaluation of the liquid droplet.

The present invention is therefore directed to the quantification of 3-D shapes of opaque (and transparence) substrates, in particular with high time resolution. In particular, the invention demonstrates the feasibility of a DIC (Differential Interference Contrast) light microscope for time resolved (TV rate) image acquisition combined with 3D quantitative evaluation of a liquid droplet as it interacts with a planar substrate. This method is most relevant for studies of wetting phenomena.

### BRIEF DESCRIPTION OF THE DRAWINGS

In order to understand the invention and to see how it may be carried out in practice, a preferred embodiment will now be described, by way of non-limiting example only, with regard to an opaque mercury droplet that wets an opaque silver substrate and with reference to the accompanying drawings, in which:

FIGS. 1 and 1a are schematic diagrams showing the principle of operation of a prior art optical differential interference contrast microscope;

FIG. 2 is a pictorial representation of a system according to the invention for determining a shape of a three-dimensional object from a planar top view thereof;

FIGS. 3 to 5 are pictorial representations showing results achieved by the system of FIG. 2;

FIG. 6 is a pictorial representation showing calibration of the system depicted in FIG. 2;

FIG. 7 is a flow diagram showing the principal actions performed by a suitably programmed computer in the system of FIG. 2 for calibrating a color-slope characteristic and correlating color data to depth during run-time; and

FIG. 8 is a flow diagram showing the principal actions performed by a suitably programmed computer in the system of FIG. 2 for correlating color data to depth during run-time using a pre-calibrated color-slope characteristic.

### DETAILED DESCRIPTION OF EXEMPLARY EMBODIMENTS

The present invention is based on the use of a differential interference contrast microscope to translate depth variations of the surface of an imaged object to changes in color or hue of the surface. For the sake of completeness, a brief introduction to differential interference contrast microscopy will now be presented.

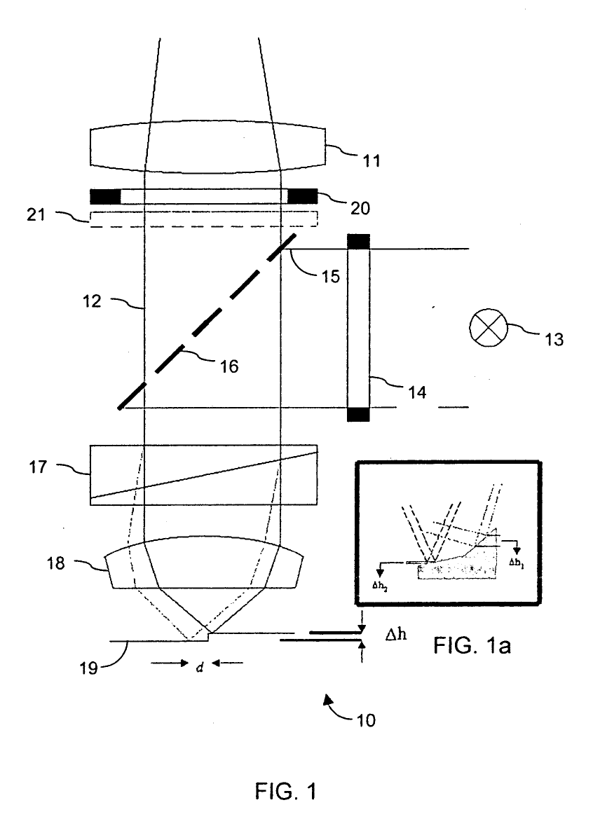

In the invention differential interference contrast microscopy is used to exploit differences in depth as will now be explained with reference to FIG. 1 showing schematically the principle of operation of a prior art optical differential interference contrast microscope 10. An objective lens 11 focuses a polarized light beam 12 obtained by directing a light source 13 through a polarizer 14 so as to direct a polarized beam of light 15 on to a semi-silvered mirror 16. The mirror 16 reflects a component of the light so that it passes through a Rochon prism 17 from which it passes through a focusing lens 18 on to the top surface 19 of an object being viewed. It is seen that where the incident light strikes the surface 19 at different depths, it is focused at points that are laterally spaced apart by an amount that depends on variations in the depth where the surface 19 is struck by the incident light. Each incident light is focused back through the focusing lens 18 and the Rochon prism 17, where the incident beams interfere and formed a combined beam that passes through the semi-silvered mirror 16 and back through a polarizer 20 and the objective lens 11 to the eye of an observer (not shown). A λ-plate 21 is employed to change the grey values into colors so that depth variations are manifested as variations on colors.

FIG. I a shows an exploded view of the incident light striking the top surface 19 of the object giving rise to laterally spaced apart beams whose dispersion is a function of the variation in depth or height where the incident beams strikes the top surface of the object. Sample and reference rays are created after the beam traverses, and is phase-distorted by, the object. Birefringence of the Rochon prism 17 separates a plane-polarized light ray into two spatially separated rays vibrating 90° apart. The position of the impinging ray relative to the Rochon prism 17 determines the phase relationship between the resulting ray pairs. The Rochon prism 17 thus splits the phase-distorted beam into two equally phased, but spatially separated (“sheared”), beams which are recombined by the polarizing filter 20. Interference of these beams at the image plane creates color variation.

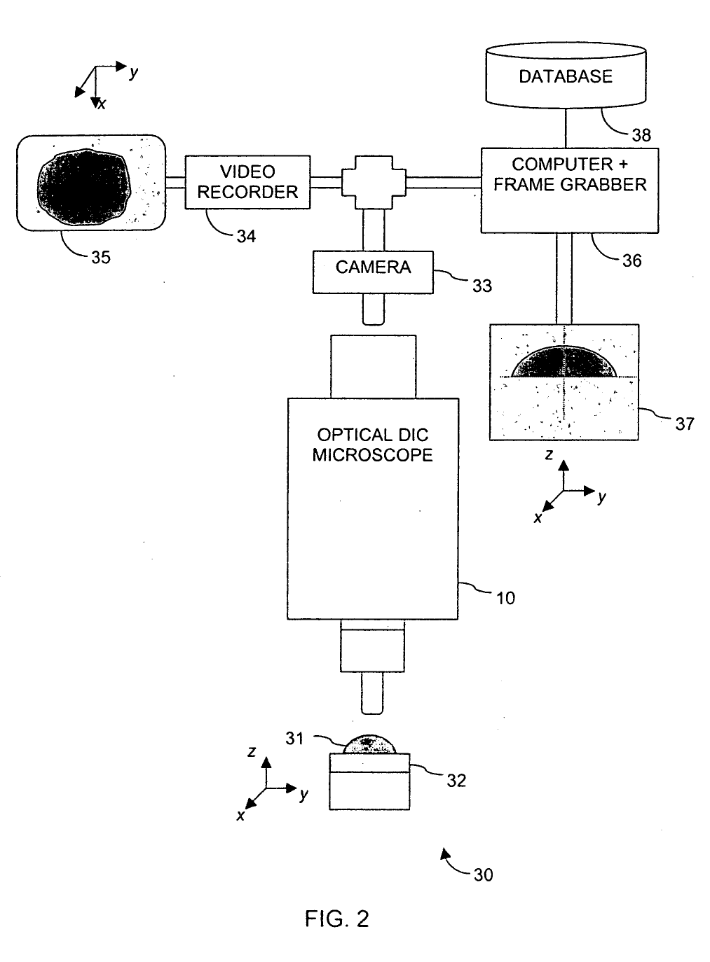

FIG. 2 is a pictorial representation of a system 30 that uses the optical differential interference contrast microscope 10 to permit quantitative polarized-light microscope measurements for determining the 3D shape of an opaque metal (Hg) droplet 31 that wets an opaque (Ag) substrate 32. The instantaneous shape of the droplet is determined from each successive frame and the data thus obtained may be processed to determine the variation in droplet shape as a function of time. Accordingly, it is possible to follow the droplet's evolution at a standard (TV) rate.

In the system 30 the spreading mercury droplet 31 is focused by the polarized differential interference contrast microscope 10 and the resulting time-varying image is photographed at high time resolution e.g. at time intervals of 0.04 seconds by a digital camera 33 so as to produce a series of time-varying frames of digital image data that are recorded by a video recorder 34 and displayed on an external monitor 35 in plan view. The digital camera 33 produces successive frames of color images. Each of the frames of digital image data is grabbed by a frame grabber which may be part of a programmed computer 36 that processes the successive frames of image data and reconstructs in elevation the spreading droplet, which is displayed on a display monitor 37.

The system 30 allows reconstruction of the three-dimensional shape of the liquid droplet that wets the solid surface with an angle resolution of 1°. The evolution of the droplet shape is determined with a time resolution of 0.04 sec. On comparing the quantitative results with other wetting-reaction systems, it is seen in particular that the droplet has a spherical-cup-shape during the entire wetting-reaction process.

In practical use of the system 30 for studying the evolution of the shape of small Hg droplets (100 μm in initial diameter) on thin Ag films (200 nm), the Ag films were thermally deposited on microscope slides in a vacuum chamber. Well-controlled smooth clean surfaces along relatively large distances are achieved when using thin Ag films rather than thick Ag foils having a thickness of 0.1 mm. The Hg droplet was placed on the silver substrate at room conditions within a few minutes to a few hours after the evaporation. The droplet propagation involves a wetting process combined with a chemical reaction and an inter-metallic compound is formed. The formula of the metallic-compound is the ε phase Ag₄Hg₃ (the detailed proof is not required for an understanding of the present invention). During this process, which takes a few minutes, the droplet changes its angle of contact giving rise to changes in the color of the surface of the mercury droplet as viewed by the polarized light microscope 10 owing to interference as explained above. In a practical embodiment reduced to practice, the polarized light microscope 10 was an Axioskop-ZEISS equipped with a DIC accessory and the digital camera was a color CCD.

The principles of qualitative polarized-light microscopy are described in detail by Robinson and Bradbury [13]. It is emphasized that visible colors are actually a result of a reduction of the intensity of some wavelengths, due to destructive interference. This method (DIC) enables the detection of steps in the specimen surface, in the order of 1/20 of the incident wavelength. Using white halogen light as a source, steps of about 20 nm are detectable. As noted above, the λ-plate changes the grey values into colors again.

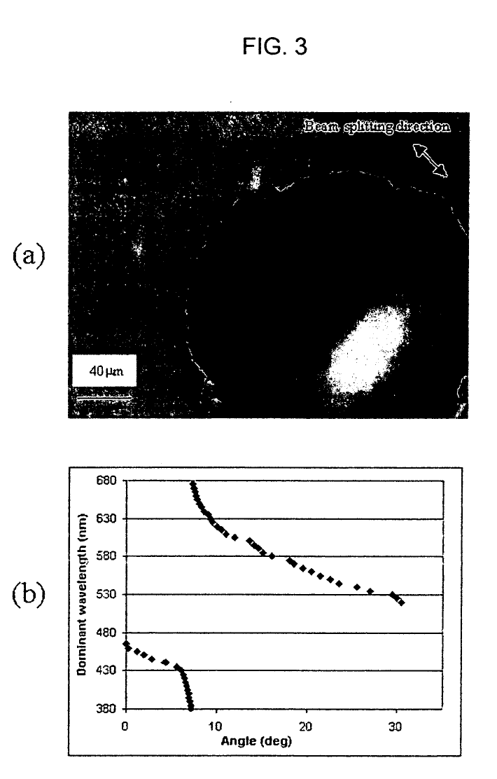

Owing to the high reflectivity of the metallic droplet, the white light is reflected. Moderate slopes of a specimen that cause small length difference between partial beams will show different colors than steeper slopes. Extremely steeper slopes reflect the light out of the objective, so that in such regions the specimen appears dark. A typical view of the droplet, with different colors representing the differences in local slopes is shown in FIG. 3a. Quantification of the colors can indicate quantitatively the local slope.

FIG. 3a shows a plan view of the Hg droplet at t=20 sec. Different angles result in different colors, the blue background being the horizontal Ag substrate. The beam splitting direction is marked. FIG. 3b shows a related color-angle chart wherein the size or the experimental spots indicates the experimental error (˜1°).

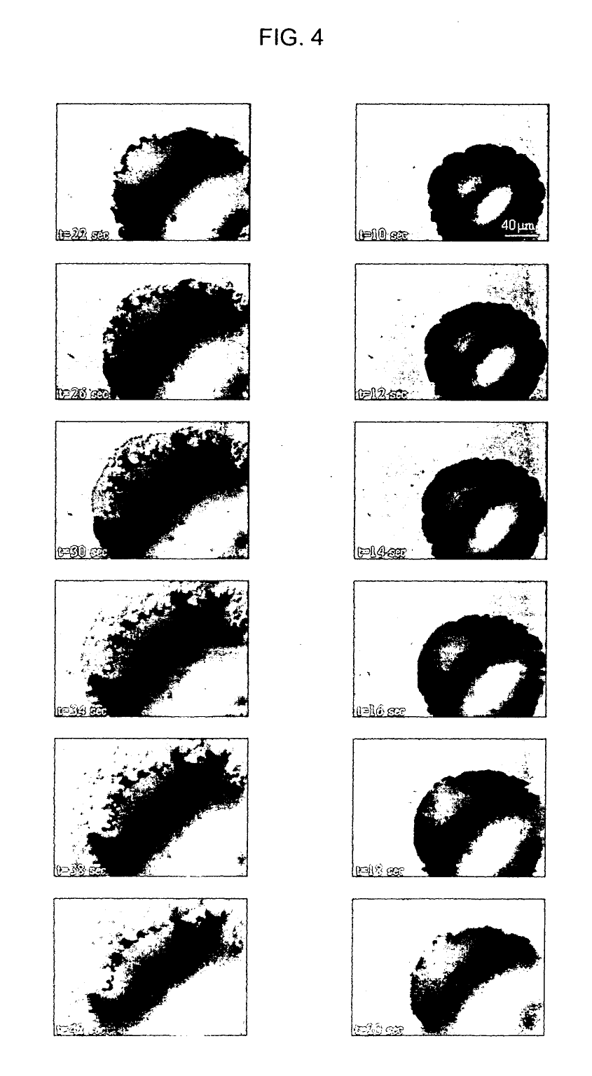

FIG. 4 shows pictorially a series of twelve plan-view snapshots of the propagating droplet. The first six pictures belong to the transient regime whereas the last six pictures belong to the major regime.

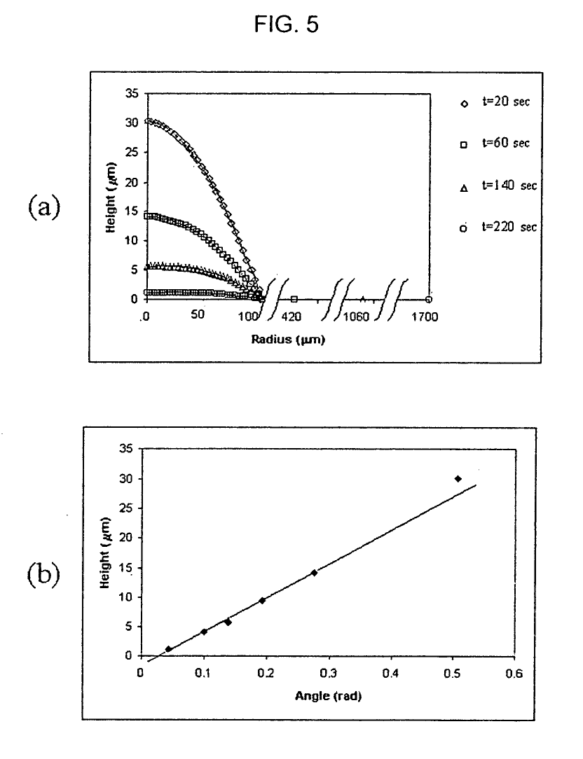

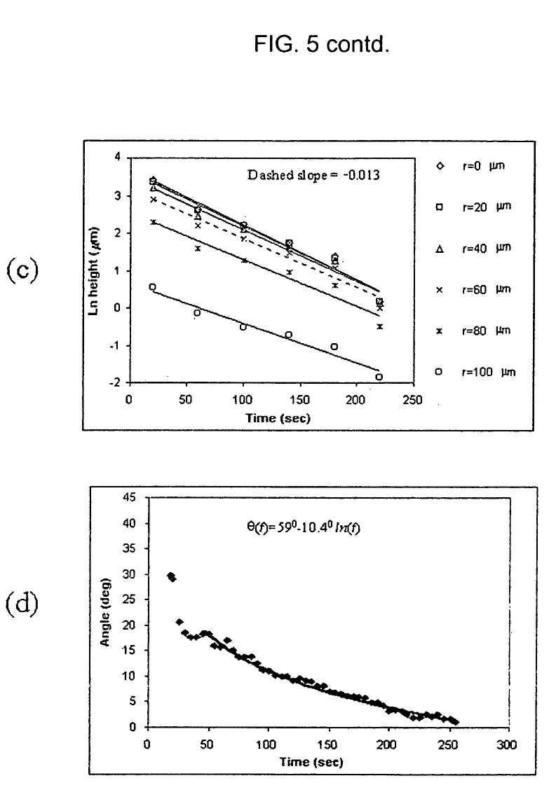

FIG. 5a shows graphically a cross-section of the droplet at various times: t=20, 60, 140, 220 sec. The corresponding marks of the thin layer to the right of the drop should be noted.

FIG. 5b shows that the slope of the straight line is approximately 54 μm, which is about a half of the radius observed in FIG. 5a, and fits

$${H}_{0} ( t ) = \frac{1}{2} R ( t ) \cdot θ ( t ) .$$

The highest point does not fall on the line as the angle to which it belongs is relatively large (29°) with respect to the spherical-cup-shape approximation.

FIG. 5c indicates that the height of the given droplet, H(r,t), (100 μm in diameter) shows an exponential decay in time, which is radially independent. r=0 corresponds to the center of the spreading droplet where H(r,t) is relatively large, whereas r=100 μm is close to the edge of the droplet in which the local height is small.

FIG. 5d shows graphically the angle of contact vs. time. Concerning the last 200 sec presented here, a logarithmic function was best fitted for the angular decay.

In order to reduce the dominant (yellow and red) wavelengths of the white source, a blue (470 nm) filter was used so as to improve the uniformity of the spectrum.

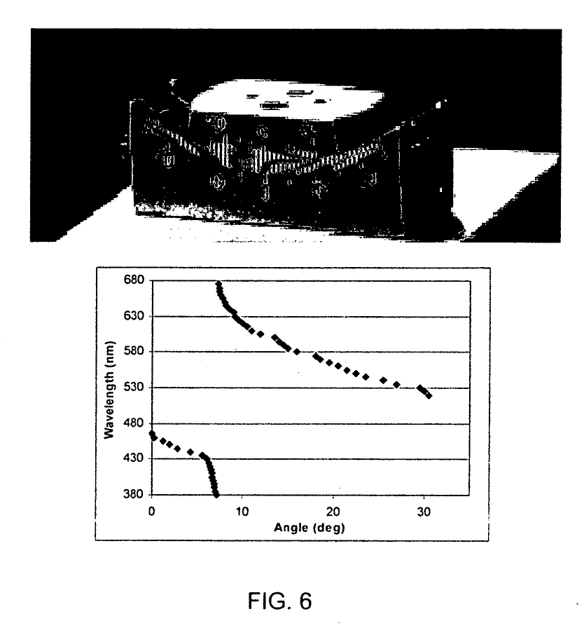

FIG. 6 shows a tilt-meter and corresponding measurements for achieving calibration of colors vs. slopes. This was performed by allowing a thin Ag film to change its position with respect to the microscope in steps of 0.5°. The tilt-meter is applicable for use with solids and in the preferred embodiment it was easier to calibrate a solid sheet of silver foil based on the established fact that the reflectivity of mercury is the same (or substantially so) as that of silver. The measurements were taken in a diametric section of the droplet parallel to the beam-splitting direction. The tilting for calibration was obtained in the same direction. It should be emphasized that the camera 33 and the video recorder 34 are engaged with the visible colors and not with wavelengths.

Calibrating liquids is generally more involved but in general requires that a small drop of liquid be disposed on a flat surface. In the case of mercury, if the diameter of the droplet be sufficiently small e.g. in the order of 200 μm, it will maintain a nearly perfectly spherical shape. On viewing from above with a polarized DIC microscope and moving out from the center of the droplet, the color changes owing to the progressive change in slope. It may be shown that:

$$\frac{r}{R} = sin ( θ )$$

where:

r=distance from center of drop;

R=radius of drop; and

θ=slope angle.

Calibration is effective until r is approximately half the value of R corresponding to a slope of 30°, after which the color appears black and further calibration is no longer possible.

For other liquid materials for which such an approach is not feasible since they spread when disposed on a flat surface, more involved techniques are required. But in principle, calibration may be performed by viewing an object from above and observing the change in color on moving outward from the center of the object and correlating the changing colors with an accurate elevation of the object that may be obtained from a photographic image. In such case, only a single pair of simultaneous images is required in plan and elevation, thus allowing the required calibration to be performed for each change in slope vs. color.

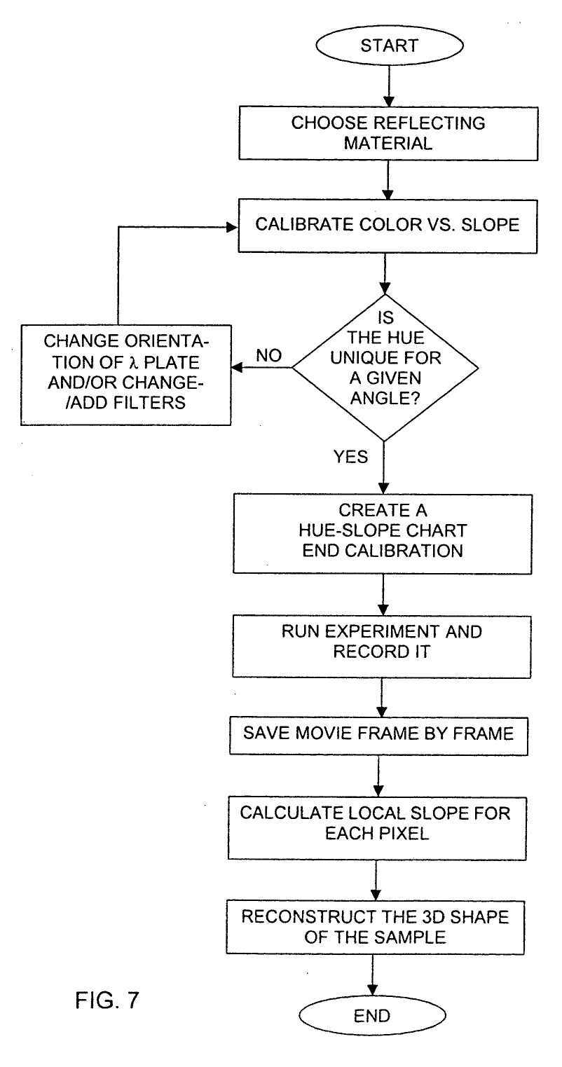

FIG. 7 is a flow diagram showing the principal actions performed by the computer 36 for translating the visible color of each pixel in the image into corresponding depth data. In order to do this, the relationship between color of reflected light and depth must be pre-calibrated for each reflecting material that is used since the relationship between depth variation and color is a function of the material. To this end, the material is placed on the tilt meter shown in FIG. 6, which is progressively tilted through successive angles and the reflected light is imaged using a digital camera and successive images are processed so as to translate the visible color of each pixel in the image, which is a triple variable function, into a dominant wavelength, which is a single variable function.

The translation is straightforward and may be done by using the HSL (Hue Saturation Luminosity) triplet and the CIE (Commission Internationale De L'Eclairage) 1931 chromaticity diagram. This procedure enables one to obtain the calibration chart of angles vs. dominant wavelength. A similar procedure that correlates polarization colors with crystal birefringence is known as the Michel-Levy chart. It was found that this procedure is capable of resolving shape angles to 1°. The results are given in FIG. 3b. The chart is periodic and should contain several orders of colors. However no signal returns from slopes that are steeper than 30°, therefore only one order of colors is observed. The chart is shifted according to the orientation of the λ-plate 21 so that it contains colors from consecutive orders and a discontinuity between them. The particular chart in FIG. 3b is for specific orientation of the λ-plate that was chosen to meet the best color response of the color CCD camera 33. In this specific chart the discontinuity between red to violet is at about 7°.

It is a requirement that the hue be unique for each discrete angle of tilt. If this requirement is not realized for the material currently being calibrated, the orientation of the λ-plate is changed and/or color filters are added until a unique color-slope characteristic can be calibrated. If the hue is unique for each discrete angle of tilt, a hue-slope chart end calibration is created.

Once calibration is achieved and the computer 36 is able to correlate color to depth for the material under investigation, the experiment is run and recorded so as to save successive frames of the resulting movie sequence. The computer then uses the pre-calibrated color-depth characteristic to calculate local slope for each pixel and the 3D shape of the sample is reconstructed. Since the color determines θ, the angle for each R may be determined. At the interface between the droplet and the substrate the height is zero. Each pixel has a different color and thus correlates to a different angle. It is also known that each pixel corresponds to a certain length in microns. Thus, the exact shape of the whole droplet can be calculated.

Although the method described above is novel, it will be understood that many components of the system 30 are available commercial products. However, in order to correlate the color of each point on the surface of the object with its depth, the computer 36 must be able to evaluate a color value for each pixel and correlate that color value with a pre-calibrated color-depth characteristic of the object. The pre-calibrated color-depth characteristic may be derived using a sample formed of an identical material to the object and stored in a database 38 accessible to the computer 36.

The database 38 may be produced by progressively tilting a sample through successive known angles and imaging light reflected therefrom using a digital color camera to produce successive images. Each of the successive images is then processed as described above so as to translate a respective triple variable function representing the color of each pixel in the image into a corresponding single variable function representing a dominant wavelength. Each single variable function is then stored on the computer readable data carrier in association with the respective slope so as to store multiple records each relating to a discrete color. Where the database contains multiple characteristics each in respect of a different material, there is further stored in association with each record data identifying the sample material.

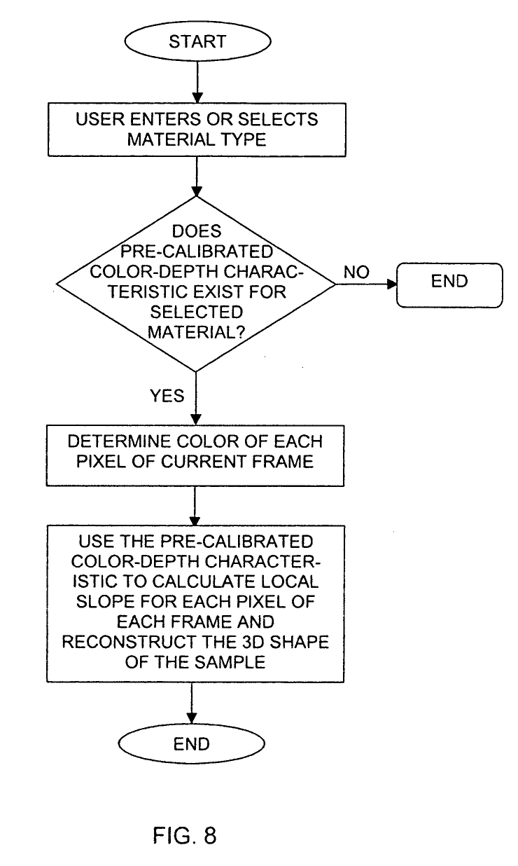

FIG. 8 is a flow diagram showing the principal actions performed by the computer 36 for correlating color data to depth during run-time using a pre-calibrated color-slope characteristic. The computer 36 may be provided with an interface for allowing user selection or entry of a material so as to allow the system 30 to be operative with different types of material. To this end, different pre-calibrated color-slope characteristics, each relating to a different material are either pre-stored in a memory of the computer or may be downloaded thereto or may be stored in a computer readable data carrier coupled to the computer. The computer readable data carrier may be a CD-ROM that is locally readable by the computer or any memory device that is locally or remotely accessible to the computer. The computer readable data carrier stores at least one pre-calibrated color-depth characteristic of an object derived using a sample formed of an identical material to an object being calibrated and allowing correlation of a color of a point on a surface of the object to a corresponding depth (i.e. slope) associated therewith.

### DISCUSSIONS AND CONCLUSIONS

The optical system 30 described above was used to study the interaction of the Hg droplets with Ag surface. The interaction is divided into two time regimes: (a) A transient regime, (about 30 sec), in which the droplet spreads on the film in a compact shape with a constant velocity (≈8 μm/sec); (b) The major regime, (about 200 sec), in which the droplet no longer propagates, but ‘feeds’ the Ag film with a thin Hg layer. A series of twelve top-view snapshots of the propagating droplet is shown in FIG. 2. This Hg film interacts with the Ag substrate, forming an inter-metallic compound with a thickness of 0.1 μm. The propagation and the geometry of the thin layer have been reported elsewhere (Be'er et al. [3], [4]). As the Hg bulk ‘feeds’ the Ag surface with a thin layer, its mass reduces with time and therefore its shape evolves.

The shape of a Hg droplet, 100 μm in diameter, was analyzed quantitatively by the above-mentioned procedure. This experiment was repeated 20 times and the results shown here belong to a typical experiment. At the interface between the droplet and the substrate the height is zero. Each pixel has a different color and thus a different angle. It is also known that each pixel corresponds to a certain length in microns. Thus, the exact shape of the whole droplet can be calculated. It is now possible to check whether

$${H}_{0} ( t ) = \frac{1}{2} R ( t ) \cdot θ ( t )$$

is satisfied.

FIG. 5a represents the droplet profiles at four stages. The height of the droplet H₀(t) and consequently the contact angle θ(t) are reduced with time whereas the radius R(t) reaches a maximum value Rₘₐₓ at t=30 sec. On the other hand a precursor thin film is formed and is continuously expanding as can be seen by the marked dots along the x-axis. It is seen in FIG. 5b that the relation

$${H}_{0} ( t ) = \frac{1}{2} R ( t ) \cdot θ ( t )$$

is satisfied, indicating that the droplet has a spherical-cup-shape independent on time up to angle of 0.5 rad.

FIG. 5c shows the evolution of the height of a given droplet at different locations r, (0<r<Rₘₐₓ) as a function of time. It is seen that for t>30 sec, the height of the given droplet H(r,t) depends on time, giving an exponential decay according to:
H(r,t)=H(r,30)e^{-0.013(t-30)} (2)
where H(r,30) is the height of the bulk at radius r at t=30 sec.

The dependence of the contact angle θ(t) on time was also studied (FIG. 5d) and found to be best fitted with a logarithmic decay:
θ(t)=59°−10.4° In(t) (3)

Note that below 50 sec there is a deviation from this function. However the standard deviation after this period was found to be 0.56° which is smaller than the experimental error as discussed above. Similar to other wetting-reaction systems (Landry & Eustathopoulos [11]; Eustathopoulos [10]), the dependence of R(t) and θ(t) on time, in this experiment, does not reveal a power law that is expected for simple wetting processes.

### SUMMARY

In conclusion, the results clearly demonstrate the ability of the optical system to construct quantitatively the 3D shape of a metal droplet that spreads on metal substrates, and its evolution with time. The present results demonstrate quantitatively for what is believed to be the first time that in a reaction-wetting process the liquid droplet has a spherical-cup-shape independent of time.

It will be appreciated that variations may be made to the method and system as described without departing from the scope of the invention as claimed. Thus while the invention has been described with regard to the interaction between mercury spreading on a silver foil substrate, it will be understood that the invention is applicable to other materials that reflect light such as tin, etc. It will also be understood that in order to evaluate the spreading of a droplet as a function of time, a movie sequence containing successive frames depicting successive stages in the evolution of the droplet must be obtained. However, the invention may also find application wherever it is desired to quantify shape of a three-dimensional object from a planar top view thereof. To the extent that this clearly may be done also for a static object, a static digital image will suffice and in this case there will be only a single frame of image data to process.

Finally, it will also be understood that the invention contemplates a computer program being readable by a computer for computing the shape of a pre-calibrated material in accordance with the invention. The invention further contemplates a machine-readable memory tangibly embodying a program of instructions executable by the machine for computing the shape of a pre-calibrated material in accordance with the invention.

1. A method for determining a shape of a three-dimensional object from a planar top view thereof, said object being amenable to reflecting light, the method comprising:
imaging the object on a planar substrate using a DIC (Differential Interference Contrast) light microscope so that the object reflects from different points of a surface of the object colors that are indicative of a slope of the surface at each respective point; and
inferring the slope of the surface at each point based on the respective color.

2. The method according to claim 1, further including:
using information representative of the respective slopes at each point of the surface to perform 3D quantitative evaluation of the object.

3. The method according to claim 1, wherein imaging the object includes deriving a digital color image comprising a plurality of pixels each having a hue that correlates to a unique slope of the surface corresponding to said pixel and inferring the slope of the surface at each point based on the respective color includes:
using a pre-calibrated color-depth characteristic derived using a sample formed of an identical material to said object to calculate local slope for each pixel.

4. The method according to claim 3, further including:
using information representative of the respective slopes at each point of the surface to perform 3D quantitative evaluation of the object.

5. The method according to claim 4, wherein performing 3D quantitative evaluation of the object includes:
assigning the local slope of each pixel to a corresponding area of the surface based on a location of each pixel and a surface dimension corresponding to each pixel; and
reconstructing the 3D shape of the object.

6. The method according to claim 3, wherein the pre-calibrated color-depth characteristic is derived by:
progressively tilting the sample through successive known angles and imaging the reflected light using a digital color camera to produce successive images;
processing each of the successive images so as to translate a triple variable function representing the color of each pixel in the image into a single variable function representing a dominant wavelength.

7. A method for evaluating a shape of a droplet as it interacts with a planar substrate, the method comprising:
imaging the droplet as it interacts with the planar substrate using a DIC (Differential Interference Contrast) light microscope for time resolved image acquisition of steps in the planar substrate, each step having a respective color indicative of a slope of the step;
inferring a slope of each step based on its color; and
using information representative of the respective slopes of the steps to perform 3D quantitative evaluation of the droplet.

8. The method according to claim 7, further including:
obtaining successive frames of the droplet at predetermined time intervals;
constructing the three-dimensional shape of the droplet in each successive frame; and
determining evolution of the droplet shape as a function of time.

9. The method according to claim 18, wherein the three-dimensional shape of the droplet is constructed with an angle resolution of 1°, and the evolution of the droplet shape is determined with a time resolution of 0.04 sec.

10. The method according to claim 7, wherein imaging the droplet includes deriving a digital color image comprising a plurality of pixels each having a hue that correlates to a unique slope of the surface corresponding to said pixel and inferring the slope of the surface at each point based on the respective color includes:
using a pre-calibrated color-depth characteristic derived using a sample formed of an identical material to said droplet to calculate local slope for each pixel.

11. The method according to claim 10, wherein constructing the three-dimensional shape of the droplet in each successive frame includes:
associating the local slope of each pixel with a corresponding area of the surface based on a location of each pixel and a surface dimension corresponding to each pixel.

12. The method according to claim 10, wherein the pre-calibrated color-depth characteristic is derived by:
progressively tilting the sample through successive known angles and imaging light reflected therefrom using a digital color camera to produce successive images;
processing each of the successive images so as to translate a respective triple variable function representing the color of each pixel in the image into a corresponding single variable function representing a dominant wavelength.

13. A system for determining a shape of a three-dimensional object from a planar top view of a top surface thereof, said top surface being amenable to reflecting light, the system comprising:
a polarized differential interference contrast microscope for imaging the top surface of the object and producing a time-varying image,
a digital color camera for photographing said time-varying image so as to derive at least one digital color image comprising a plurality of pixels each having a hue that correlates to a unique slope of the top surface corresponding to said pixel,
a frame grabber for grabbing the at least one digital color image,
a computer coupled to the frame grabber for processing the at least one digital color image and determining the slope of the top surface at each pixel based on the respective color of each pixel so as to produce a respective reconstructed view of the object in elevation corresponding to each digital color image, and
a display device coupled to the computer for displaying the reconstructed view of the object.

14. The system according to claim 13, wherein:
the digital color camera is configured to photograph the time-varying image at high time resolution so as to produce a series of time-varying frames of digital image data, and
the computer is configured to process successive frames of image data and reconstruct the object so as to produce a reconstructed view of the object in elevation.

15. The system according to claim 13, further including:
a database storing at least one pre-calibrated color-depth characteristic derived using a sample formed of an identical material to said object;
said computer being coupled to the database for extracting therefrom a pre-calibrated color-depth characteristic of said object and for calculating therefrom local slope for each pixel based on the respective color thereof.

16. The system according to claim 15, wherein the computer is configured to performing 3D quantitative evaluation of the object by assigning the local slope of each pixel to a corresponding area of the surface based on a location of each pixel and a surface dimension corresponding to each pixel.

17. A computer readable data carrier storing at least one pre-calibrated color-depth characteristic of an object derived using a sample formed of an identical material to said object and allowing correlation of a color of a point on a surface of the object to a corresponding depth associated with said point.

18. A method for producing the computer readable data carrier according to claim 17, the method comprising:
progressively tilting the sample through successive known angles and imaging light reflected therefrom using a digital color camera to produce successive images;
processing each of the successive images so as to translate a respective triple variable function representing the color of each pixel in the image into a corresponding single variable function representing a dominant wavelength; and
storing multiple records each relating to a discrete color and containing a corresponding single, variable function in association with the respective slope.

19. The method according to claim 18, wherein the database contains multiple characteristics each in respect of a different material, and there is further included:
storing in association with each record data identifying the sample material.

20. A program storage device readable by machine, tangibly embodying a program of instructions executable by the machine to perform method steps for determining a shape of a three-dimensional object from a planar top view thereof, said object being amenable to reflecting light, the method comprising:
processing a digital color image of the object as viewed on a planar substrate using a DIC (Differential Interference Contrast) light microscope so that the object reflects from different points of a surface of the object colors that are indicative of a slope of the surface at each respective point;
accessing a color-depth characteristic of said object; and
inferring the slope of the surface at each point based on the respective color.

21. A computer program product comprising a computer useable medium having computer readable program code embodied therein for determining a shape of a three-dimensional object from a planar top view thereof, said object being amenable to reflecting light, the computer program product comprising:
computer readable program code for causing the computer to process a digital color image of the object as viewed on a planar substrate using a DIC (Differential Interference Contrast) light microscope so that the object reflects from different points of a surface of the object colors that are indicative of a slope of the surface at each respective point; and
computer readable program code for causing the computer to access a color-depth characteristic of said object and infer the slope of the surface at each point based on the respective color.
